(19) United States
(12) Patent Application Publication
(10) Pub. No.: US 2007/0135123 A1
(43) Pub. Date: Jun. 14, 2007

(54) Method and apparatus for flexible alerting using a packet gateway

(75) Inventors: Frances Mu-Fen Chin, Naperville, IL (US); Cynthia Kae Florkey, Chicago, IL (US)

Correspondence Address: JENNER & BLOCK LLP, ONE IBM PLAZA, CHICAGO, IL, 60611, US

(73) Assignee: Lucent Technologies Inc.

(21) Appl. No.: 11/301,774

(22) Filed: Dec. 13, 2005

(51) Int. Cl. H04Q 7/20

(52) U.S. Cl. 455/433

(57) ABSTRACT

A packet gateway (114) implements a flexible alerting feature. The packet gateway receives an incoming call for a number (202), determines a first home location register associated with the incoming call and requests location information for the incoming call from the first home location register (204). If the called number associated with the incoming call is a pilot directory number that relates to a flexible alerting feature, the packet gateway receives a termination list and an indication that the call is a flexible alerting call (206). If the termination list includes a directory number that is associated with a network that is served by the packet gateway, then the packet gateway determines a second home location register associated with that directory number (208, 210). The packet gateway requests location information from the second home location register and based on the location information from the second home location register, delivers the incoming call to a mobile switching system that is serving a device associate with the at least one directory number (216).

### FIELD OF THE INVENTION

The present invention relates generally to telecommunications systems, and in particular, to a method and apparatus for providing flexible alerting using a packet gateway.

### BACKGROUND OF THE INVENTION

Flexible alerting is a known telecommunications feature that provides the ability to group more than one directory number (“DN”) together for the purpose of alerting or ringing the group simultaneously. The group of directory numbers are assigned a pilot DN. When an incoming call arrives for the pilot DN, all of the member DNs of the group are alerted simultaneously. In other words, a call to the pilot DN causes all of the directory numbers of the group to “ring.” When the call is answered by a DN in the group, the network completes the call to that DN and abandons the attempt to alert the other DNs. That is, the first directory number to answer the call is connected to the caller and the other directory numbers are no longer alerted.

Flexible alerting is generally implemented for a particular telecommunications technology. For example, flexible alerting may be implemented for a CDMA (code division multiple access) or a GSM (global system for mobile) system. In such systems, if a pilot DN terminates at a mobile switching center, (“MSC”), then the MSC determines the list of directory numbers that form the flexible alerting group by accessing a home location register. The directory numbers in the flexible alerting group are either a local number, an intersystem number or a public switched telephone network (“PSTN”) number. A local number is a number for a device that is presently in communication with the MSC via a base station connected to the MSC. An intersystem number is a directory number for a device within the same service provider's network and using the same technology, but currently in communication with another MSC. A PSTN number is a directory number that is neither local nor intersystem but is available over the PSTN. According to this scheme, if a directory number in the flexible alerting group, also referred to as the termination list, is for a device that is not of the same technology as the pilot DN, then that number is considered a PSTN number. And PSTN numbers are all forwarded to the public switched telephone network for alerting. In some cases, for service providers that support more than one telecommunications technology, there is the possibility that a member of the termination list, while not of the same technology as the pilot DN, resides on a network that is owned by the same service provider that terminates the pilot DN. Under the present scheme, such a number would be considered a PSTN number and would be forwarded to the PSTN, even though the directory number could be reached over the service provider's internal network without being forwarded to the public switched telephone network. Forwarding a call to the public switched telephone network, when in fact it could be completed without being delivered to the public switched telephone network, is wasteful and expensive. Nonetheless, there presently is no alternative to this scheme because mobile switching centers and the associated home location registers only communicate within a homogenous technology. That is, a mobile switching center for a GSM system only communicates with the GSM home location register. For service providers with multiple networks, the GSM mobile switching center and home location register are not aware of, or in communication with, a service providers network of another technology, for example CDMA.

Packet gateways are switching systems that provide mobile termination call processing for circuit (e.g., time-division multiplexed) connections and packet (e.g., Internet Protocol—IP) connections. Packet gateways are also referred to as gateway MSCs. Packet gateways are typically not connected to cell sites or base stations. Packet gateways are often used to coordinate telecommunications services for a service provider that has networks of different technologies. For example, a service provider arranges its networks such that all calls are directed to a packet gateway, rather than to a MSC for a particular technology. Because packet gateways are capable of communicating with MSCs and home location registers (HLRs) of multiple technologies, the packet gateway is effective in directing calls to the appropriate MSC and associated HLR, if necessary.

Presently, for flexible alerting in networks employing a packet gateway, the packet gateway receives the call to the pilot DN and forwards that call to the appropriate MSC for traditional treatment. That is, the MSC accesses its associated HLR to determine whether the flexible alerting group member DNs are either local numbers, intersystem numbers, or PSTN numbers, as described above. In this case, a PSTN number may in fact be within the terminating service providers network, but merely a device associated with a portion of the network that is of a different technology. In this case, as discussed above, it is wasteful to alert this type of directory number over the public switched telephone network. In particular, network resources are unnecessarily utilized. In addition, the time for routing the call is unnecessarily increased. This is especially undesirable because it is desirable to alert all of the member DN's of a termination list simultaneously for an effective flexible alerting feature.

Therefore, a need exists for a fast and efficient implementation of a flexible alerting feature for service providers employing networks of different technology types.

### SUMMARY OF THE INVENTION

The need is met and an advance in the art is made by the present invention, which uses a packet gateway to direct flexible alerting calls to members of a termination list without accessing the public switched telephone network.

A method according to an aspect of the invention is provided for a flexible alerting call. A packet gateway receives an incoming call for a pilot directory number. The packet gateway determines a first home location register associated with the incoming call and requests location information for the incoming call from the first home location register. The packet gateway then receives an indication that the pilot directory number relates to a flexible alerting feature and a termination list. If the termination list includes a directory number that is associated with a network that is served by the packet gateway, then the packet gateway determines a second home location register associated with that number. The packet gateway requests location information from the second home location register and based on the location information from the second home location register, delivers the incoming call to a mobile switching system that is serving a device associated with that directory number.

An apparatus according to an aspect of the invention includes a packet gateway with a processor. The processor receives an incoming call for a number, determines a first home location register associated with the incoming call and requests location information for the incoming call from the first home location register. If the called number associated with the incoming call is a pilot directory number that relates to a flexible alerting feature, the packet gateway receives a termination list and an indication that the call is a flexible alerting call. If the termination list includes a directory number that is associated with a network that is served by the packet gateway, then the packet gateway determines a second home location register associated with that directory number. The packet gateway requests location information from the second home location register and based on the location information from the second home location register, delivers the incoming call to a mobile switching system that is serving a device associated with the directory number.

### BRIEF DESCRIPTION OF THE DRAWINGS

FIG. 1 is a block diagram of a communications system that implements a flexible alerting feature according to a preferred embodiment of the present invention.

FIG. 2 is a flow chart illustrating a method for flexible alerting according to a preferred embodiment of the present invention.

### DETAILED DESCRIPTION OF THE PREFERRED EMBODIMENTS

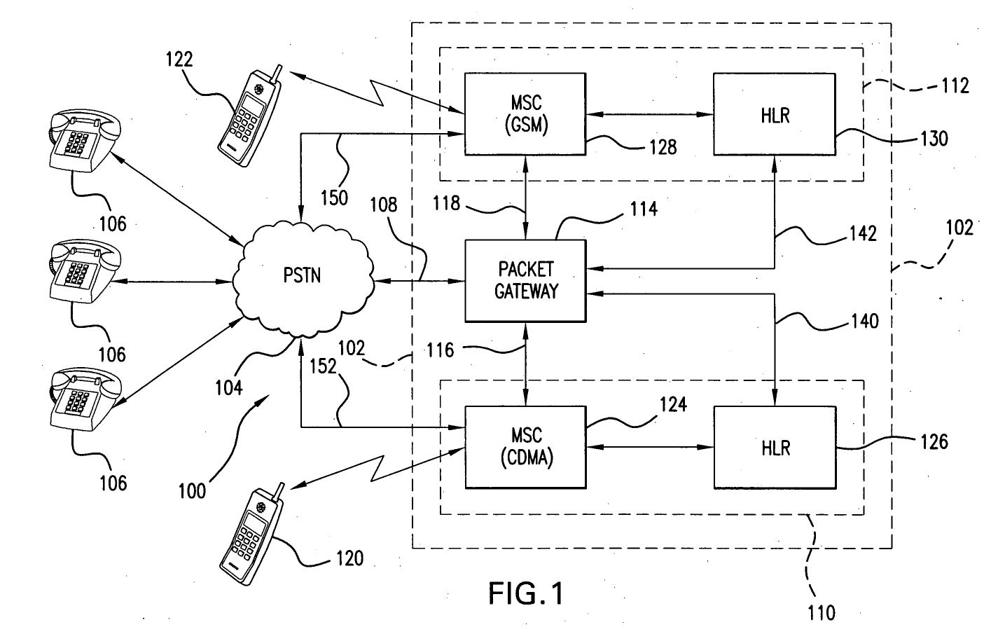

FIG. 1 is a block diagram of a communications system in accordance with an embodiment of the present invention. Communications system 100 includes a service provider's network 102 and the public switched telephone network (PSTN) 104. PSTN 104 couples devices such as telephones 106 to each other and other devices for voice communication in a well-known manner. Service provider network 102 includes switches and other devices owned and controlled by one service provider, such as a wireless telecommunications service provider. The service provider (SP) network 102 is coupled to the PSTN 104 for voice and data communications via communications links 108. SP network 102 couples a service provider's customers' communications devices to each other and to the public switched telephone network 104.

SP network 102 is a network that includes multiple wireless communications technology networks or sub-networks. In particular, SP network 102 includes a CDMA (code division multiple access) network 110 and a GSM (global system for mobile) network 112. In a well-known manner, CDMA network 110 couples wireless devices, such as CDMA telephone 120, to other devices on CDMA network 110 and to other devices, such as telephones 106, that are coupled to the public switched telephone network 104. Similarly, GSM network 112 couples wireless devices, such as GSM telephone 122, to other devices on GSM network 112 and to other devices, such as telephones 106, that are coupled to the public switched telephone network 104.

A packet gateway 114 is coupled to both the CDMA network 110 and the GSM network 112 via communications links 116 and 118, respectively. There is no direct connection between CDMA network 110 and GSM network 112. The packet gateway 114 provides a link between the CDMA network 110 and the GSM network 112. Hence, wireless communications devices coupled to the CDMA network 110 and wireless communications devices coupled to the GSM network 112 communicate with each other through packet gateway 114, without the need for communications through PSTN 104. Alternatively, wireless communications devices coupled to the CDMA network 110 and wireless communications devices coupled to the GSM network 112 communicate with each other through separate communication links 150 and 152 to the PSTN 104. Notably, it is faster and less costly for the service provider if wireless communications devices coupled to the CDMA network 110 and wireless communications devices coupled to the GSM network 112 communicate with each other through packet gateway 114, since no resources outside of the SP network 102 are needed to complete such communications.

CDMA network 110 preferably includes mobile switching systems, such as mobile switching system (MSC) 124, which are coupled to home location registers, such as home location register 126, in a manner known to those of skill in the art. For simplicity, only mobile switching system 124 and home location register 126 are shown in FIG. 1 and discussed below. Similarly, GSM network 112 preferably includes mobile switching systems, such as mobile switching system 128, which are coupled to home location registers, such as home location register 130, in a manner known to those of skill in the art. Notably, MSC 124 and MSC 128 provide an analogous function, but since these MSCs function in different communications networks, these mobile switching systems do not directly communicate with each other. Also, HLR 126 and HLR 130 provide an analogous function in their respective networks, but the mobile switching systems in the CDMA network 110 communicate with the HLR 126 and the mobile switching systems in the GSM network 112 communicate with HLR 130, due to the difference in the communications technologies used in these networks. The packet gateway 114 is connected to both HLR 126 and HLR 130 via communication links 140 and 142, respectively.

Packet gateway 114 is preferably one or more processors programmed to perform traditional packet gateway features and to perform according to the functions described herein. Packet gateway 114 preferably has interfaces for coupling for communication to MSCs of different technologies and HLRs for different technologies. Packet gateway 114 has an interface(s) to the PSTN. An exemplary packet gateway is the LUCENT PLEXUS 9000™ available from Lucent Technologies Inc., Murray Hill, N.J.

Heretofore, placing a flexible alerting call to a pilot directory number (DN) in a CDMA network, such as CDMA network 110, resulted in paging any CDMA devices in the SP network 102, without using resources outside of the SP network 102 (assuming a MSC in the SP network is serving the appropriate CDMA devices). If the pilot DN included within the flexible alerting group any devices that were not coupled to CDMA network 110, then those devices were paged or alerted through connections to the PSTN 104. Hence, even if a device were coupled to SP network 102 via the GSM network 112, a flexible alerting call that included that device in the flexible alerting group resulted in establishing connections to PSTN 104 to page or alert such devices. In accordance with the principles of the present invention, a flexible alerting call to a pilot DN in one network type or a sub-network does not require establishing connections through the public switched telephone network for devices associated with another network or sub-network within a single service providers network. Hence, if a pilot DN is resident on CDMA network 110 and a directory number in the flexible alerting group associated with that pilot DN is resident on GSM network 112, then paging of the device on the GSM network is accomplished without utilizing resources outside of SP network 102.

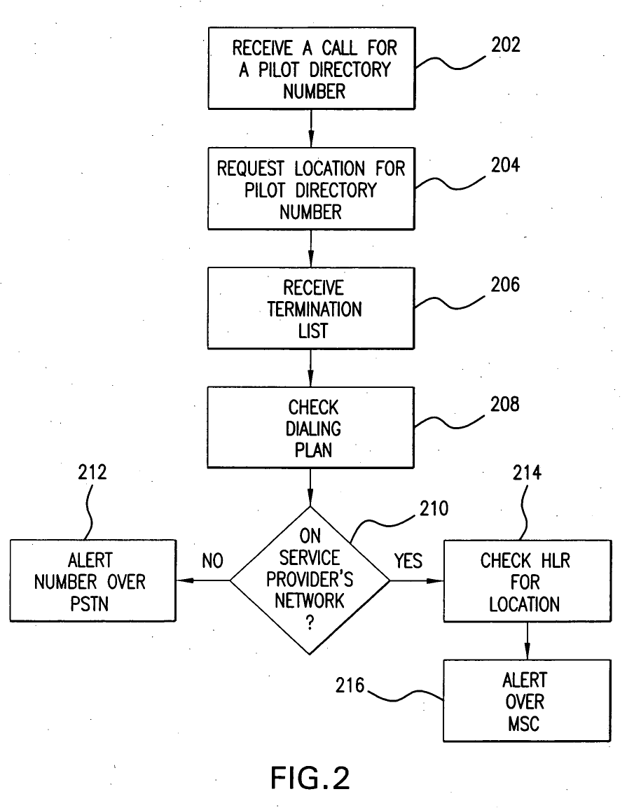

FIG. 2 is a flow chart illustrating a preferred method for flexible alerting according to the principles of the invention. FIG. 2 is described below with reference to the devices depicted in FIG. 1.

First, packet gateway 114 receives an incoming call for a pilot DN that is associated with the SP network 102 (202). The called number is the pilot DN. The incoming call is routed to the packet gateway 114 in the normal manner. According to the normal procedure for receipt of calls, the packet gateway 114 preferably returns an acknowledgement message.

The packet gateway 114 then sends a to HLR 126 to determine the location of the device associated with the called number (204). At the time the ANSI-41 location request is made, the packet gateway 114 is not aware that the called number is a pilot DN for a flexible alerting feature. HLR 126 determines that the called number is a pilot DN for a flexible alerting feature. HLR 126 retrieves the list of numbers associated with the flexible alerting group identified by the pilot DN. This list is referred to as the termination list. The termination list identifies whether a number in the list is local, intersystem, or PSTN. For any numbers in the termination list that are associated directly with and served by the CDMA network, routing request are made to the serving MSCs for those devices. The HLR 126 knows which MSC in CDMA network 110 is serving a particular CDMA device. The serving MSC returns the routing information, including the TLDN (temporary local directory number) for any of the members of the flexible alerting group, to the HLR 126. The HLR 126 builds the response to the packet gateway's ANSI-41 location request for the called party (the pilot DN), in the termination list. As with the prior flexible alerting feature, the termination list that is returned identifies each member of the flexible alerting group as either an intersystem member or a PSTN member, since there are no numbers or devices that are local to packet gateway 114. An intersystem member is a member of the group that is associated with the CDMA network 110. All others are PSTN members.

When the packet gateway 114 receives the termination list from the HLR 126 (206), the PG knows that the call is a flexible alerting call. Therefore, the PG may play an announcement to the caller, for example, an announcement indicating the call is being connected and the caller should continue to wait.

The PG 114, based on the termination list and the designations therein, initiates pages to the intersystem members. That is, the PG 114 routes the call to the serving MSCs for the intersystem members. Those MSCs then page the intersystem members. According to the prior flexible alerting feature, the PG would then send all the PSTN designated members to the PSTN 104 for alerting. However, in accordance with the present invention, the PG 114 checks the dialing plan for the members designated PSTN to determine if any of those members are associated with the GSM network 112 (208). If there are any such numbers (210), then rather than execute a call setup to those numbers over the public switched telephone network, the PG 114 routes the call to those members using SP network 102. More specifically, PG 114 queries HLR 130 via link 142 with a LOCREQ message, which is a request for routing information on those members (214). In response, HLR 130 sends the ROUTEREQ message to the serving MSCs. And, the serving MSCs return the TLDNs to the HLR130, which returns this routing information to the PG 114. With the routing information, the PG 114 routes the call to the serving MSCs, which in turn alert the mobile devices. Then those members that are outside the SP network 102 that were designated in the termination list as PSTN are alerted by initiating call setup messages towards the PSTN 104 (212). When the call is answered by one member of the flexible alerting group, then the other calls or call legs are released and the incoming call is connected to the member that answered the call. The order in which members of the flexible alerting group are alerted may vary.

In an alternate embodiment, a new termination type is defined and returned by the HLR, so that the packet gateway 114 can determine whether a member of a termination list is on the SP network 102 without checking a dialing plan. The new termination type identifies members of the flexible alerting group that are not intersystem members, but are within the service provider's network. In this alternate embodiment, communications system 100 operates as described above with respect to FIG. 2, except that after the termination list is received (206) there is no need to check the dialing plan to determine if a “PSTN” number is within the service provider's network (208). Instead the new termination type returned from the HLR provides this information directly. This indication is preferably provisioned in the home location register and is used in step 210 to determine if the number is actually accessible only through the PSTN and not within the service provider's network. Numbers with the new termination type are alerted by the serving MSCs in response to the PG 114 sending the call to the serving MSCs, as described above with respect to steps 214, 216. PSTN numbers are alerted in response to the PG 114 sending the call to those numbers, as described above with respect to step 212.

The present invention provides efficiency in the operation of a flexible alerting feature. Advantageously, network resources are not wasted for flexible alerting calls that are completely within a service provider's network, even if the pilot directory number is of a different technology than other members of the flexible alerting group.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A method for a flexible alerting call, the method comprising the steps of:
a packet gateway receiving an incoming call for a pilot directory number;
the packet gateway determining a first home location register associated with the incoming call and requesting location information for the incoming call from the first home location register;
the packet gateway receiving an indication that the pilot directory number relates to a flexible alerting feature;
the packet gateway receiving a termination list including at least one directory number associated with the flexible alerting feature associated with the pilot directory number;
determining if the at least one directory number is associated with a network that is served by the packet gateway;
if the at least one directory number is associated with the network that is served by the packet gateway, then determining a second home location register associated with the at least one directory number;
requesting location information from the second home location register; and
based on the location information from the second home location register, delivering the incoming call to a mobile switching system that is serving a device associate with the at least one directory number.

2. The method of claim 1 wherein the step of determining if the at least one directory number is associated with a network that is served by the packet gateway includes determining whether a termination type provided by the first home location register indicates the at least one directory number is associated with a network that is served by the packet gateway.

3. The method of claim 1 wherein the step of determining if the at least one directory number is associated with a network that is served by the packet gateway, includes the packet gateway determining whether the at least one directory number is within a network that is served by the packet gateway.

4. The method of claim 3 wherein the step of determining whether the at least one directory number is within a network that is served by the packet gateway includes checking a dialing plan.

5. The method of claim 2 wherein the termination type is distinguishable from a public switched telephone network termination type that identifies a member of the termination list that is not associated with the network.

6. The method of claim 2 wherein the first home location register is coupled to, and associated with, a code division multiple access network and the second home location register is coupled to, and associated with, a global system for mobile network.

7. An apparatus for a flexible alerting call comprises:
a packet gateway including a processor that:
receives an incoming call for a pilot directory number;
determines a first home location register associated with the incoming call;
requests location information for the incoming call from the first home location register;
wherein the packet gateway receives an indication that the pilot directory number relates to a flexible alerting feature;
wherein the packet gateway receives a termination list including at least one directory number associated with the flexible alerting feature associated with the pilot directory number; and
wherein the packet gateway determines if the at least one directory number is associated with a network that is served by the packet gateway;
wherein if the at least one directory number is associated with the network that is served by the packet gateway, then the packet gateway determines a second home location register associated with the at least one directory number;
wherein the packet gateway requests location information from the second home location register and based on the location information from the second home location register, delivers the incoming call to a mobile switching system that is serving a device associate with the at least one directory number.

8. The apparatus of claim 7 wherein the packet gateway determines if the at least one directory number is associated with a network that is served by the packet gateway by checking a dialing plan.

9. The apparatus of claim 7 wherein the packet gateway determines if the at least one directory number is associated with a network that is served by the packet gateway based upon a termination type received from the first home location register.

10. The apparatus of claim 9 wherein the termination type is distinguishable from a public switched telephone network termination type that identifies a member of the termination list that is not associated with the network.

11. The apparatus of claim 7 wherein the first home location register is coupled to, and associated with, a code-division multiple access network and the second home location register is coupled to, and associated with, a global system for mobile network.
